(19) United States
(12) Patent Application Publication
(10) Pub. No.: US 2011/0182071 A1
(43) Pub. Date: Jul. 28, 2011

(54) BEAM IRRADIATION DEVICE AND SEMICONDUCTOR LASER DEVICE

(75) Inventors: Takaaki Morimoto, Kakogawa-City (JP); Masato Yamada, Inuyama-City (JP)

(73) Assignee: SANYO Electric Co., Ltd., Moriguchi-shi (JP)

(21) Appl. No.: 13/005,721

(22) Filed: Jan. 13, 2011

(30) Foreign Application Priority Data
Jan. 28, 2010 (JP) 2010-016781

(51) Int. Cl. G02B 27/20

(52) U.S. Cl. 362/259

(57) ABSTRACT

A beam irradiation device includes a semiconductor laser; a lens into which laser light emitted from the semiconductor laser is entered; and a scanning portion which causes the laser light transmitted through the lens to scan a targeted area. In this arrangement, the semiconductor laser has a laser chip; a cap which houses the laser chip; and an emission opening formed in the cap and adapted to pass laser light emitted from the laser chip. The emission opening has an aperture which restricts an incident area of the laser light into the lens.

This application claims priority under 35 U.S.C. Section 119 of Japanese Patent Application No. 2010-016781 filed Jan. 28, 2010, entitled “BEAM IRRADIATION DEVICE AND SEMICONDUCTOR LASER DEVICE”. The disclosure of the above application is incorporated herein by reference.

### BACKGROUND OF THE INVENTION

1. Field of the Invention

The present invention relates to a beam irradiation device for irradiating a targeted area with laser light, and a semiconductor laser device to be loaded in the beam irradiation device.

2. Disclosure of Related Art

In recent years, a laser radar system has been loaded in a family automobile or a like vehicle to enhance safety in driving. Generally, the laser radar system is so configured as to scan a targeted area with laser light to detect presence or absence of an obstacle at each of scanning positions, based on presence or absence of reflected light at each of the scanning positions. The laser radar system is also configured to detect a distance to the obstacle, based on a required time from an irradiation timing of laser light to a light receiving timing of reflected light at each of the scanning positions.

A beam irradiation device is loaded in a laser radar system to irradiate a targeted area with laser light. Generally, the beam irradiation device shapes laser light into a predetermined shape to irradiate a targeted area with the laser light. The beam shaping is performed by an aperture and a beam shaping lens.

In the above laser radar system, a semiconductor laser may be used as a laser light source. Laser light is emitted from both of an emission surface (front surface) and a surface (rear surface) opposite to the emission surface of a laser chip of the semiconductor laser. The laser light emitted from the rear surface side may be used to e.g. control the power of the laser light emitted from the front surface side. In the case where the laser light from the rear surface side is not used for power control, the laser light from the rear surface side is reflected in the interior of a cap (CAN) for housing the laser chip, and then emitted through an emission opening of the cap. As a result of the emission, the laser light from the rear surface side is also irradiated onto the targeted area.

Since the laser light from the rear surface side is emitted through the emission opening after reflection in the interior of the cap, the laser light from the rear surface side may propagate in a direction different from the direction of the laser light emitted from the front surface side. As a result, the laser light (stray light) from the rear surface side may be irradiated onto the targeted area at a position slightly displaced from the irradiation position of the laser light emitted from the front surface (emission surface). In this way, if unwanted laser light (stray light) is irradiated onto a targeted area, erroneous detection may occur resulting from the unwanted laser light (stray light), and detection precision of the laser radar system may be lowered.

### SUMMARY OF THE INVENTION

A first aspect of the invention is directed to a beam irradiation device. The beam irradiation device according to the first aspect includes a semiconductor laser; a lens into which laser light emitted from the semiconductor laser is entered; and a scanning portion which causes the laser light transmitted through the lens to scan a targeted area. In this arrangement, the semiconductor laser has a laser chip; a cap which houses the laser chip; and an emission opening formed in the cap and adapted to pass laser light emitted from the laser chip. The emission opening has an aperture which restricts an incident area of the laser light into the lens.

A second aspect of the invention is directed to a semiconductor laser device. The semiconductor laser device according to the second aspect includes a laser chip; a cap which houses the laser chip; and an emission opening formed in the cap and adapted to pass laser light emitted from the laser chip.

The emission opening has an aperture which blocks light at an outer portion of the laser light. The aperture blocks laser light in a range where an intensity of the laser light on abeam's long axis is smaller than about 1/e² of a peak intensity of the laser light.

### BRIEF DESCRIPTION OF THE DRAWINGS

These and other objects, and novel features of the present invention will become more apparent upon reading the following detailed description of the embodiment along with the accompanying drawings.

FIG. 1 is an exploded perspective view of a mirror actuator in an embodiment of the invention.

FIGS. 2A and 2B are diagrams showing a process of assembling the mirror actuator in the embodiment.

FIGS. 3A and 3B are diagrams showing a process of assembling the mirror actuator in the embodiment.

FIG. 4 is a diagram showing an optical system of the beam irradiation device in the embodiment.

FIGS. 5A and 5B are diagrams showing an optical system of the beam irradiation device in the embodiment.

FIGS. 6A through 6C are diagrams for describing a relation between an emission opening and a lens in the embodiment.

FIG. 7 is a diagram for describing a method for defining an emission opening in the embodiment.

FIGS. 8A through 8D are diagrams schematically showing an advantage of the embodiment.

FIGS. 9A through 9E are diagrams showing modifications of the embodiment.

The drawings are provided mainly for describing the present invention, and do not limit the scope of the present invention.

### DESCRIPTION OF PREFERRED EMBODIMENTS

In the following, a beam irradiation device embodying the invention is described referring to the drawings. The beam irradiation device of the embodiment is adapted to be loaded in a vehicle-mounted laser radar system. Firstly, a mirror actuator to be mounted in the beam irradiation device is described.

A mirror actuator 100 in the embodiment corresponds to a scanning portion in the claims. A transparent plate 401g in the embodiment corresponds to a transparent cover member in the claims.

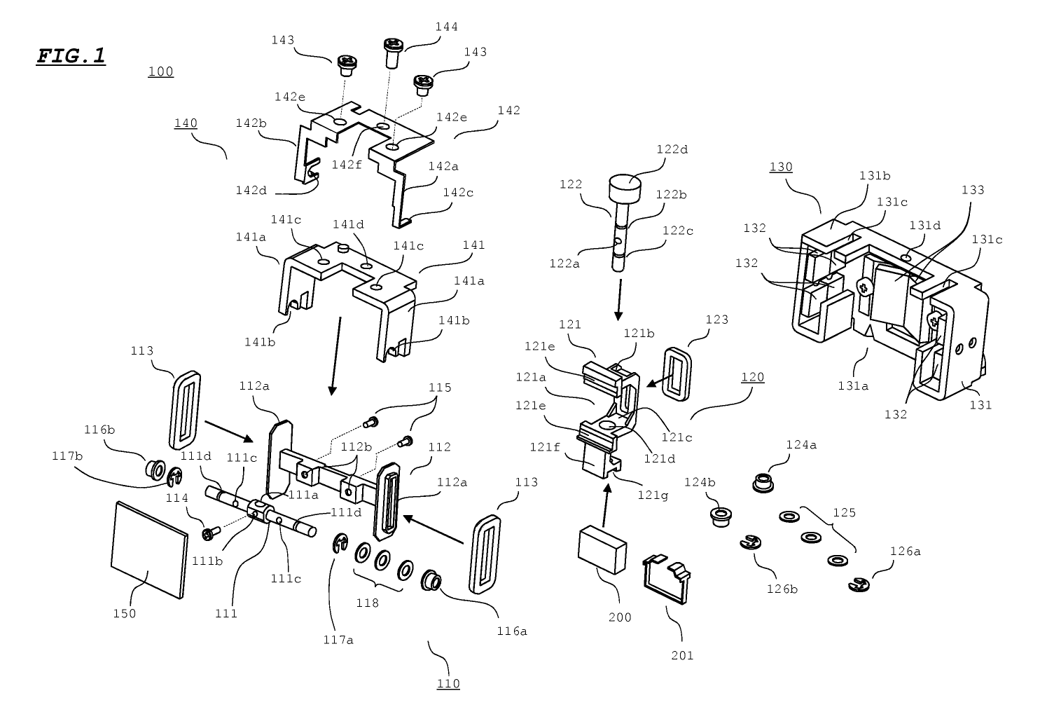

FIG. 1 is an exploded perspective view of a mirror actuator 100.

The mirror actuator 100 is provided with a tilt unit 110, a pan unit 120, a magnet unit 130, a yoke unit 140, a mirror 150, and a transparent member 200.

The tilt unit 110 is provided with a support shaft 111, a tilt frame 112, and two tilt coils 113. The support shaft 111 is formed with a vertically extending through-hole 111a in the middle thereof, and a screw through-hole 111b communicating with the through-hole 111a from the front side of the mirror actuator 100. The support shaft 111 is further formed with horizontally extending two screw through-holes 111c, and is further formed with two grooves 111d near both ends of the support shaft 111.

The tilt frame 112 is formed with coil mounting portions 112a at left and right ends thereof for mounting the tilt coils 113. The tilt frame 112 is further formed with horizontally extending two screw through-holes 112b at positions corresponding to the screw holes 111c of the support shaft 111.

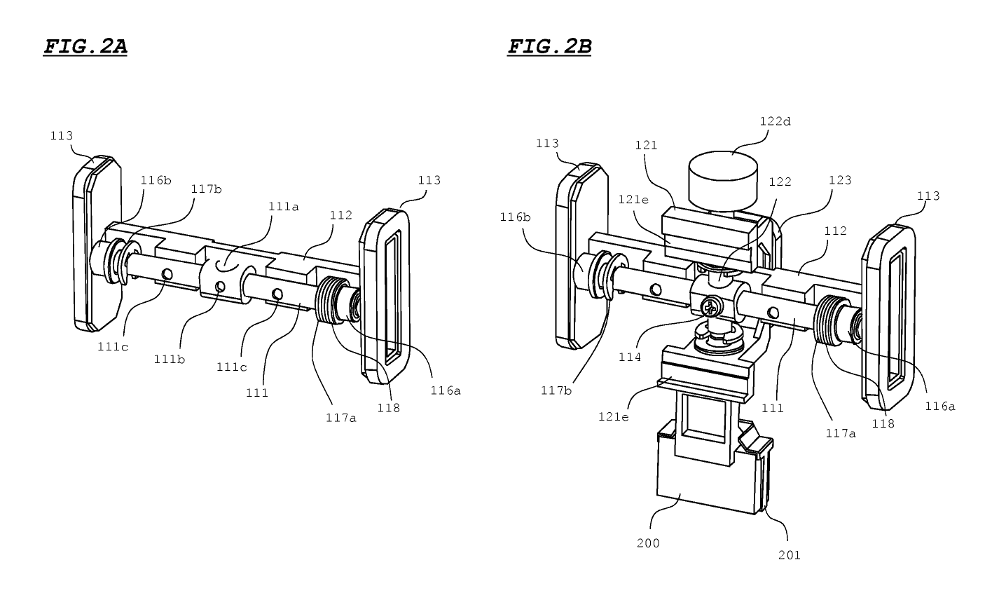

The support shaft 111 is mounted on the tilt frame 112 by fastening two screws 115 into the two screw holes 111c and the two screw holes 112b of the support shaft 111 from the rear side of the mirror actuator 100 in a state that the two screw holes 111c oppose to the two screw holes 112b of the tilt frame 112. Further, as shown in FIG. 2A, the tilt unit 110 is assembled by mounting the tilt coils 113 on the coil mounting portions 112a of the tilt frame 112 from left and right sides of the mirror actuator 100. FIG. 2A shows a state that bearings 116a and 116b, E-rings 117a and 117b, and three polyslider washers 118 are mounted on the support shaft 111.

The pan unit 120 is mounted on the assembled tilt unit 110 in the manner as described below. Thereafter, the tilt unit 110 is attached to a yoke 141 in the manner as described below, using the bearings 116a and 116b, the E-rings 117a and 117b, the polyslider washers 118, and a shaft fixing member 142.

Referring back to FIG. 1, the pan unit 120 is provided with a pan frame 121, a support shaft 122, and a pan coil 123. The pan frame 121 is formed with an upper plate portion 121b and a lower plate portion 121c, with a recess portion 121a being formed therebetween. The upper plate portion 121b and the lower plate portion 121c are formed with vertically aligned through-holes 121d for passing the support shaft 122. Further, a step portion 121e is formed on a front surface of each of the upper plate portion 121b and the lower plate portion 121c for placing a mirror 150. Furthermore, a downwardly extending leg portion 121f is formed on the lower plate portion 121c, and a recess portion 121g for receiving the transparent member 200 is formed in the leg portion 121f. A coil mounting portion (not shown) for mounting the pan coil 123 is formed on the back surface of the pan frame 121.

The support shaft 122 is formed with a horizontally extending screw through-hole 122a, and is further formed with grooves 122b and 122c in upper and lower positions thereof with respect to the screw hole 122a. A balancer 122d is attached to an upper end of the support shaft 122. The distance between the two grooves 122b and 122c is set smaller than the distance between the inner side surface of the upper plate portion 121b of the pan frame 121 and the inner side surface of the lower plate portion 121c of the pan frame 121.

The magnet unit 130 is provided with a frame 131, two pan magnets 133, and eight tilt magnets 132. The frame 131 has such a shape that a recess portion 131a is formed on the front side thereof. An upper plate portion 131b of the frame 131 is formed with horizontally extending two cutaways 131c, and is further formed with a screw hole 131d in the middle thereof. The eight tilt magnets 132 are mounted in upper and lower two rows on the left and right inner surfaces of the frame 131. Further, as shown in FIG. 1, the two pan magnets 133 are mounted on the rear inner surface of the frame 131 with a certain inward inclination.

The yoke unit 140 is provided with the yoke 141 and the shaft fixing member 142. The yoke 141 is constituted of a magnetic member. The yoke 141 is formed with wall portions 141a at left and right sides thereof, and recess portions 141b for mounting the support shaft 111 of the tilt unit 110 are formed in respective lower ends of the wall portions 141a. The yoke 141 is formed with vertically extending two screw through-holes 141c in an upper portion thereof, and is further formed with a screw hole 141d at a position corresponding to the screw hole 131d of the magnet unit 130. The distance between the inner side surfaces of the two wall portions 141a is set larger than the distance between the two grooves 111d of the support shaft 111.

The shaft fixing member 142 is a thin plate metal member having flexibility. Plate spring portions 142a and 142b are formed on a front portion of the shaft fixing member 142. Receiving portions 142c and 142d for restricting falling of the bearings 116a and 116b of the tilt unit 110 are formed on respective lower ends of the plate spring portions 142a and 142b. Further, an upper plate portion of the shaft fixing member 142 is formed with holes 142e at positions corresponding to the two screw holes 141c of the yoke 141, and is further formed with a hole 142f at a position corresponding to the screw hole 141d of the yoke 141.

In assembling the mirror actuator 100, after the tilt unit 110 as shown in FIG. 2A is assembled as described above, the pan unit 120 is mounted on the support shaft 111 of the tilt unit 110 as follows.

Firstly, the bearings 124a and 124b are placed in the holes 121d respectively formed in the upper plate portion 121b and the lower plate portion 121c of the pan frame 121 from the side of the recess portion 121a, and fixedly mounted. Then, the pan coil 123 is mounted on the back surface of the pan frame 121. Further, the transparent member 200 is placed in the recess portion 121g of the pan frame 121, and the transparent member 200 is fixed to the leg portion 121f of the pan frame 121 by a transparent member fixing bracket 201.

Thereafter, the tilt frame 112 and the support shaft 111 are inserted in the recess portion 121a of the pan frame 121, and then, the hole 111a of the support shaft 111 and the bearings 124a and 124b mounted on the pan frame 121 are vertically aligned. In this state, the support shaft 122 is passed through the hole 111a and the bearings 124a and 124b from the upper side of the mirror actuator 100. In assembling the parts, the three polyslider washers 125 are passed through the support shaft 122 within the recess portion 121a. Further, the screw hole 111b of the support shaft 111 and the screw hole 122a of the support shaft 122 are aligned with each other, and a screw 114 is fastened into the screw hole 111b and into the screw hole 122a from the front side of the mirror actuator 100. With this operation, the support shaft 122 is fixed to the support shaft 111.

Thereafter, the pan frame 121 is slidingly moved so that the three polyslider washers 125 are located below the lower-side groove 122c of the support shaft 122, and the E-ring 126b is mounted in the lower-side groove 122c. Further, the upper-side groove 122b of the support shaft 122 is positioned in the recess portion 121a, and the E-ring 126a is mounted in the groove 122b. With this operation, as shown in FIG. 2B, the pan unit 120 is mounted on the tilt unit 110. In this state, the pan frame 121 is pivotally movable about the support shaft 122, and is slightly movable up and down along the support shaft 122.

After the pan unit 120 is mounted as described above, the mirror 150 is placed in the step portions 121e of the pan frame 121, and fixed thereat. Thereafter, the bearings 116a and 116b mounted on both ends of the support shaft 111 of the tilt unit 110 are placed in the recess portions 141b of the yoke 141 shown in FIG. 1. Then, in this state, the shaft fixing member 142 is mounted on the yoke 141 so that the bearings 116a and 116b do not fall from the recess portions 141b. Specifically, the shaft fixing member 142 is mounted on the yoke 141 in such a manner that the receiving portion 142c holds the bearing 116a from below, and that the receiving portion 142d holds the bearing 116b from the front side of the mirror actuator 100. In this state, two screws 143 are fastened into the screw holes 141c of the yoke 141 through the two holes 142e of the shaft fixing member 142. Thereby, a structure member shown in FIG. 2B is mounted on the yoke unit 140.

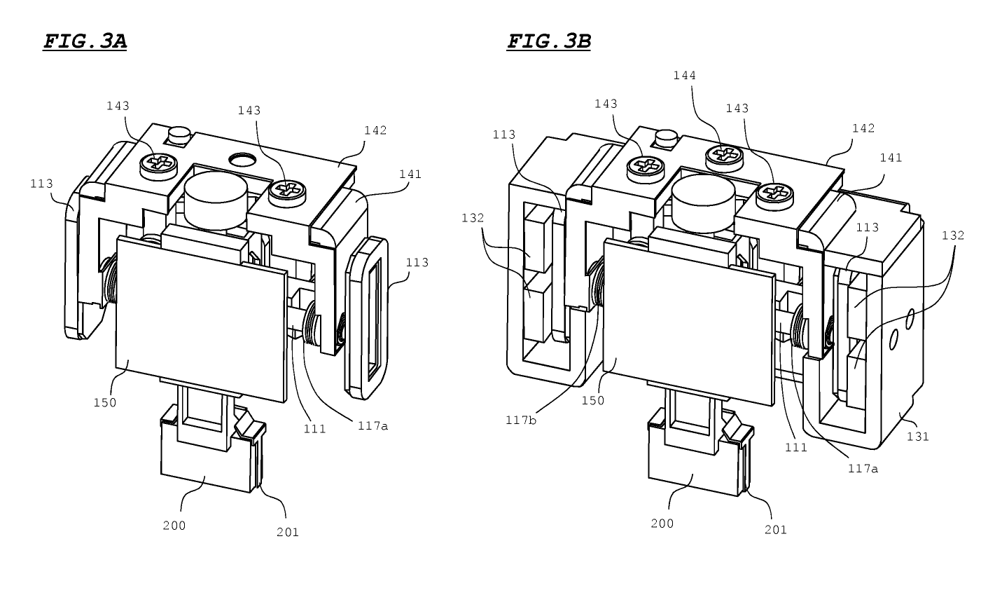

In this way, a structure member shown in FIG. 3A is assembled. In this state, the tilt frame 112 is pivotally movable about the support shaft 111 with the pan frame 121, and is slightly movable transversely along the support shaft 111.

The assembled structure member shown in FIG. 3A is mounted on the magnet unit 130 in such a manner that the two wall portions 141a of the yoke 141 are respectively inserted in the cutaways 131c of the frame 131 of the magnet unit 130. Then, in this state, a screw 144 is fastened into the screw hole 141d of the yoke 141 and in the screw hole 131d of the magnet unit 130 through the hole 142f of the shaft fixing member 142. With this operation, the structure member shown in FIG. 3A is fixedly mounted to the magnet unit 130. Thus, assembling the mirror actuator 100 is completed, as shown in FIG. 3B.

In the assembled state shown in FIG. 3B, when the pan frame 121 is pivotally moved about the support shaft 122, the mirror 150 is also pivotally moved with the pan frame 121. Further, when the tilt frame 112 is pivotally moved about the support shaft 111, the pan unit 120 is pivotally moved with the tilt frame 112, and the mirror 150 is pivotally moved with the pan unit 120. In this way, the mirror 150 is supported on the support shafts 111 and 122 orthogonal to each other to be pivotally movable, and is pivotally moved about the support shafts 111 and 112 by energization of the tilt coils 113 and the pan coil 123. At the same time, the transparent member 200 mounted on the pan unit 120 is pivotally moved in accordance with the pivotal rotation of the mirror 150.

The balancer 122d is adapted to adjust pivotal movement of the structure member shown in FIG. 2B about the support shaft 111 in a well-balanced manner. The balancing of pivotal movement is adjusted by the weight of the balancer 122d. Alternatively, as far as the balancer 122d is vertically displaceable, it is possible to adjust the balancing of pivotal movement by finely adjusting the position of the balancer 122d in a vertical direction.

In the assembled state shown in FIG. 3B, the dispositions and the polarities of the eight tilt magnets 132 are adjusted so that a force for pivotally moving the tilt frame 112 about the support shaft 111 is generated by application of a current to the tilt coils 113. Accordingly, when a current is applied to the tilt coils 113, the tilt frame 112 is pivotally moved about the support shaft 111 by an electromagnetic force generated in the tilt coils 113, and the mirror 150 and the transparent member 200 are pivotally moved with the tilt frame 112.

Further, in the assembled state shown in FIG. 3B, the dispositions and the polarities of the two pan magnets 133 are adjusted so that a force for pivotally moving the pan frame 121 about the support shaft 122 is generated by application of a current to the pan coil 123. Accordingly, when a current is applied to the pan coil 123, the pan frame 121 is pivotally moved about the support shaft 122 by an electromagnetic force generated in the pan coil 123, and the mirror 150 and the transparent member 200 are pivotally moved with the pan frame 121.

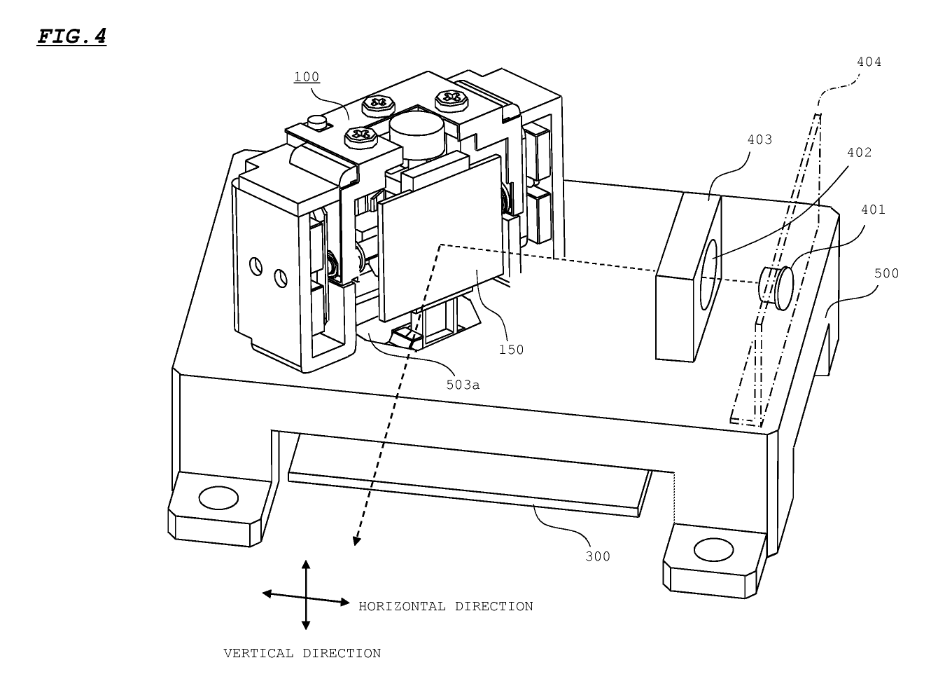

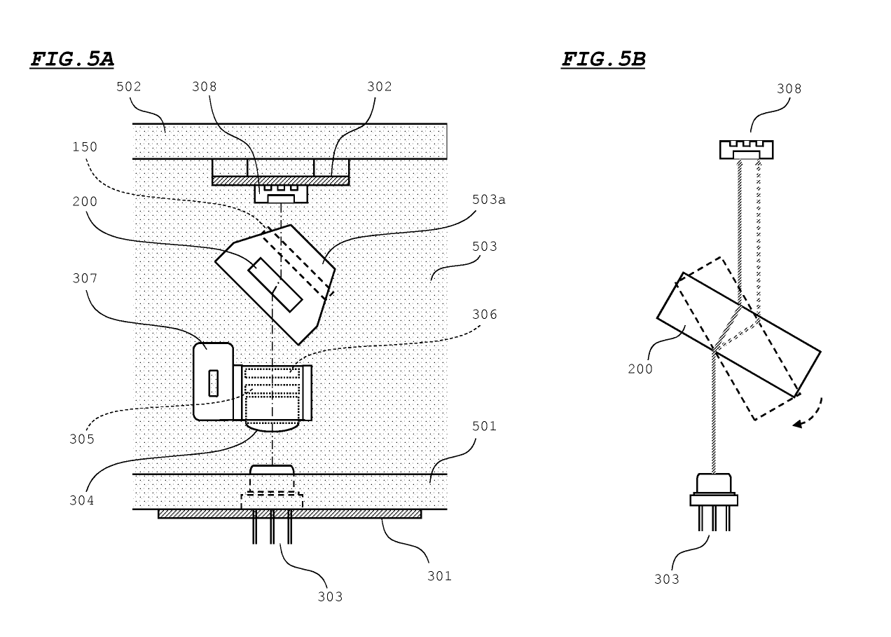

FIGS. 4, 5A, and 5B are diagrams showing an arrangement of a beam irradiation device incorporated with the mirror actuator 100.

FIG. 4 is a diagram showing a scan optical system of the beam irradiation device. In FIG. 4, the reference numeral 500 denotes a base block. In FIG. 4, the top surface of the base block 500 is made horizontal. The base block 500 is formed with an opening 503a at a position where the mirror actuator 100 is installed, and the mirror actuator 100 is mounted on the base block 500, with the transparent member 200 being placed in the opening 503a. The mirror actuator 100 is mounted on the base block 500 in a state that up and down directions shown in FIG. 1 is aligned with a vertical direction shown in FIG. 4.

A semiconductor laser 401, and a beam shaping lens 402 are disposed on the top surface of the base block 500. The semiconductor laser 401 is mounted on a semiconductor laser substrate 404 disposed on the top surface of the base block 500. Further, the lens 402 is set on the top surface of the base block 500 in a state that the lens 402 is held on a lens holder 403.

Laser light emitted from the semiconductor laser 401 is converged in a horizontal direction and a vertical direction by the lens 402. The lens 402 is designed in such a manner that the beam shape on a targeted area (e.g. defined at a position forwardly away from the beam emission opening of the beam irradiation device by about 100 m) has a predetermined size (e.g. a size of about 2 m in a vertical direction and about 1 m in a transverse direction).

Laser light transmitted through the lens 402 is entered into the mirror 150 of the mirror actuator 100, and is reflected toward a targeted area by the mirror 150. The targeted area is scanned with the laser light when the mirror 150 is driven by the mirror actuator 100 about two axes.

The mirror actuator 100 is disposed at such a position that laser light from the lens 402 is entered into a mirror surface of the mirror 150 with an incident angle of 45 degrees with respect to the horizontal direction, when the mirror 150 is set to a neutral position. The term “neutral position” indicates a position of the mirror 150, wherein the mirror surface is aligned in parallel to the vertical direction, and laser light is entered into the mirror surface with an incident angle of 45 degrees with respect to the horizontal direction.

A circuit board 300 is disposed underneath the base block 500. Further, circuit boards 301 and 302 are disposed on side surfaces of the base block 500.

FIG. 5A is a partially plan view of the base block 500, when viewed from the back surface side of the base block 500. FIG. 5A shows an arrangement of a servo optical system and peripheral parts thereof disposed on the back surface of the base block 500.

As shown in FIG. 5A, walls 501 and 502 are formed along the perimeter of the back surface of the base block 500. A flat surface 503 lower than the walls 501 and 502 is formed in a middle portion of the back surface of the base block 500 with respect to the walls 501 and 502. The wall 501 is formed with an opening for mounting a semiconductor laser 303. The circuit board 301 loaded with the semiconductor laser 303 is attached to an outer side surface of the wall 501 in such a manner that the semiconductor laser 303 is placed in the opening of the wall 501. Further, the circuit board 302 loaded with a PSD 308 is attached to a position near the wall 502.

A light collecting lens 304, an aperture 305, and a neutral density (ND) filter 306 are mounted on the flat surface 503 on the back surface of the base block 500 by an attachment member 307. The flat surface 503 is formed with the opening 503a, and the transparent member 200 mounted on the mirror actuator 100 is projected from the back surface of the base block 500 through the opening 503a. In this example, when the mirror 150 of the mirror actuator 100 is set to the neutral position, the transparent member 200 is set to such a position that the two flat surfaces of the transparent member 200 are aligned in parallel to the vertical direction, and are inclined by 45 degrees with respect to an optical axis of emission light from the semiconductor laser 303.

Laser light (hereinafter, called as “servo light”) emitted from the semiconductor laser 303 is transmitted through the light collecting lens 304, has the beam diameter thereof reduced by the aperture 305, and has the light intensity thereof reduced by the ND filter 306. Thereafter, the servo light is entered into the transparent member 200, and is refracted by the transparent member 200. Thereafter, the servo light transmitted through the transparent member 200 is received by the PSD 308, which, in turn, outputs a position detection signal depending on a light receiving position of the servo light.

FIG. 5B is a diagram schematically showing a relation between a pivotal position of the transparent member 200 and an optical path of servo light. FIG. 5B only shows the transparent member 200, the semiconductor laser 303, and the PSD 308 in FIG. 5A to simplify the description.

Servo light is refracted by the transparent member 200 disposed with an inclination with respect to an optical axis of laser light, and is received by the PSD 308. In this example, in the case where the transparent member 200 is pivotally moved in the direction of broken-line arrow in FIG. 5B, the optical path of servo light is changed from the solid-line state to the dotted-line state shown in FIG. 5B, with the result that the light receiving position of servo light on the PSD 308 is changed. Thus, the pivotal position of the transparent member 200 can be detected by the light receiving position of servo light to be detected by the PSD 308. A pivotal position of the transparent member 200 corresponds to a scanning position of laser light in a targeted area. Accordingly, it is possible to detect a scanning position of laser light in a targeted area based on a signal from the PSD 308.

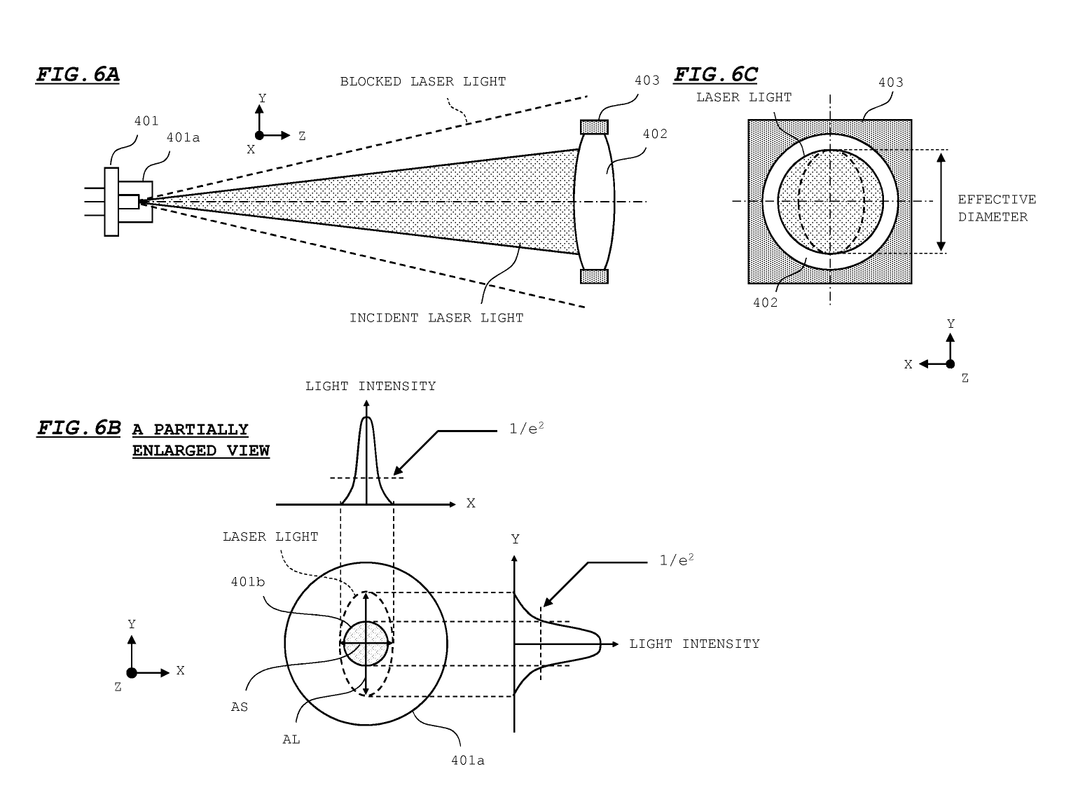

FIG. 6A is a diagram schematically showing a relation between the semiconductor laser 401 and the lens 402. FIG. 6B is a partially enlarged view of the semiconductor laser 401 when viewed from Z-axis direction. FIG. 6B shows a relation between a cap 401a, an emission opening 401b formed in the cap 401a, and laser light. The broken line in FIG. 6B schematically shows an incident area of laser light with respect to a back surface of the cap 401a. FIG. 6B also shows an intensity distribution, on abeam's long axis (AL) and a beam's short axis (AS), of laser light to be entered into the back surface of the cap 401a.

In this embodiment, the emission opening 401b serves as an aperture for restricting the incident area of laser light into the lens 402. The direction of laminating semiconductor layers of a laser chip housed in the cap 401a is aligned with Y-axis direction in FIGS. 6A through 6C. Accordingly, the divergence angle of laser light in Y-axis direction is larger than that of X-axis direction. As a result, laser light is entered into an elliptical area on the back surface of the cap 401a, as shown in FIG. 6B.

As shown in FIG. 6B, the emission opening 401b has a circular shape. The emission opening 401b is disposed at such a position that the optical axis of laser light is aligned with the center of the emission opening 401b. The diameter of the emission opening 401b is set to be equal to the width of a range where the intensity of laser light on the beam's long axis (AL) becomes equal to or larger than 1/e² of a peak intensity of the laser light. With this arrangement, a portion of laser light on the beam's long axis, which is near the center of the emission opening 401b, i.e., whose intensity is equal to or larger than 1/e² of a peak intensity of the laser light, passes through the emission opening 401b; and a portion of laser light on the beam's long axis, which is away from the center of the emission opening 401b, i.e., whose intensity is smaller than 1/e² of the peak intensity, is blocked by the back surface of the cap 401a.

The beam's short axis (AS) of laser light is set slightly larger than the diameter of the emission opening 401b. Accordingly, laser light is blocked by the back surface of the cap 401a in the direction of the beam's short axis, as well as the direction of the beam's long axis. As a result, laser light is shaped by the emission opening 401b so that the cross section of the laser light has a circular shape.

The shaped laser light is entered into the lens 402, as shown in FIG. 6A. FIG. 6C is a diagram showing a relation between laser light and the lens 402 when the lens 402 is viewed from the laser light incident side. The broken line in FIG. 6C shows an area of laser light, where the intensity is equal to or larger than 1/e² of the peak intensity. The lens 402 converges laser light so that the entered laser light (laser light whose intensity is equal to or larger than 1/e² of the peak intensity) has a predetermined shape in a targeted area.

In this embodiment, as shown in FIG. 6C, since laser light is entered into an area having the effective diameter of the lens 402, there is no likelihood that laser light may interfere with an inner periphery of the lens holder 403. Thus, there is no likelihood that laser light interfered by the lens holder 403 may be irradiated onto the targeted area as stray light.

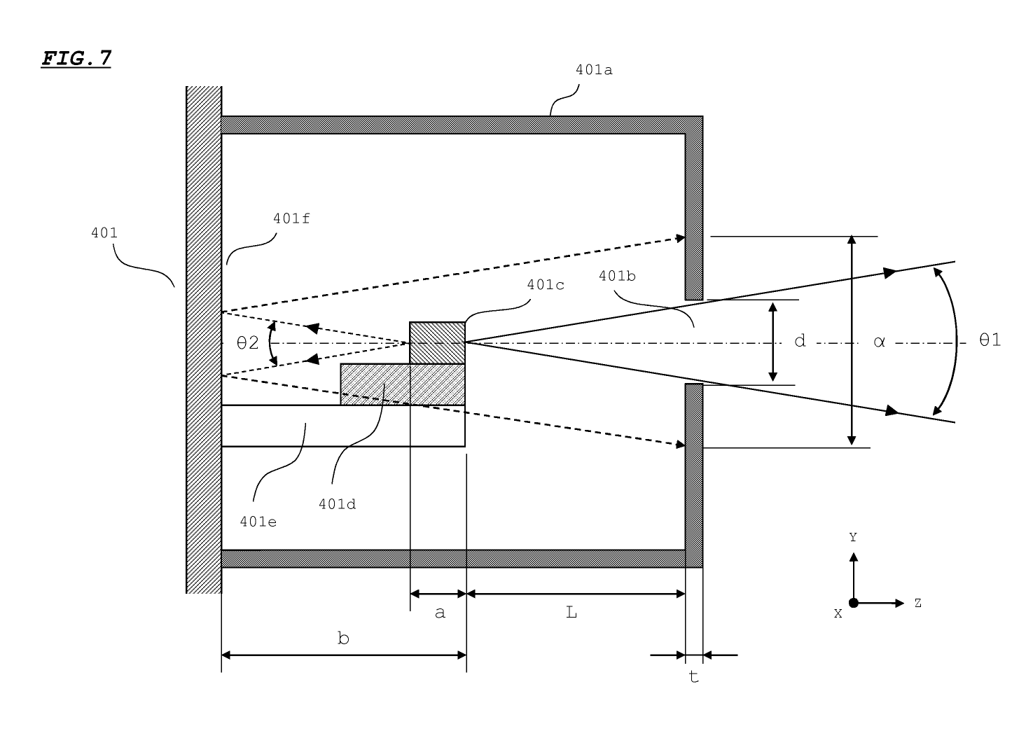

FIG. 7 is an internal perspective view of the semiconductor laser 401 when viewed from X-axis direction. As shown in FIG. 7, a laser chip 401c is disposed in the cap 401a. The laser chip 401c is formed on a sub mount 401d, and the sub mount 401d is supported on a stem 401f via a block 401e.

The laser chip 401c emits laser light from both of a front surface (emission surface) and a rear surface thereof. As described above, laser light emitted from the front surface of the laser chip 401c is propagated toward the emission opening 401b and the back surface of the cap 401a in the periphery of the emission opening 401b, and a central portion of the laser light is transmitted through the emission opening 401b and entered into the lens 402. Laser light emitted from the rear surface of the laser chip 401c is reflected on the stem 401f.

In this example, assuming that L is a distance from the front surface of the laser chip 401c to an inner surface of the cap 401a, “t” is a thickness of the cap 401a at a portion corresponding to the emission opening 401b, and θ1 is a total divergence angle of laser light, on the beam's long axis, whose intensity lies in a range of 1/e² or more of a peak intensity of the laser light, the diameter “d” of the emission opening 401b is set to a value calculated by the following equation (1).

d=2×{(L+t)tan(θ1/2)} (1)

By setting the diameter “d” as described above, a portion of laser light, on the beam's long axis, which is near the center of the emission opening 401b, i.e., whose intensity is equal to or larger than 1/e² of a peak intensity of the laser light, passes through the emission opening 401b; and a portion of laser light, on the beam's long axis, which is away from the center of the emission opening 401b, i.e., whose intensity is smaller than 1/e² of the peak intensity, is blocked by the back surface of the cap 401a. Thus, laser light is entered into the lens 402, as shown in FIG. 6C, and is irradiated onto a targeted area with an intended shape.

In the case where the emission point of the laser chip 401c is displaced by ±Δr1 in the direction of X-Y plane and the emission opening 401b is displaced by ±Δr2 in the direction of X-Y plane by production tolerance, the diameter “d” of the emission opening 401b may be set to a value calculated by the following equation (2).

d=2×{(L+t)tan(θ1/2)+(r1+r2)} (2)

Further, as shown in FIG. 7, laser light (stray light) emitted from the rear surface of the laser chip 401c and reflected on the stem 401f is also propagated toward the emission opening 401b and the back surface of the cap 401a in the periphery of the emission opening 401b. The diameter a of the beam's long axis of laser light (stray light) on the back surface of the cap 401a is calculated by the following equation (3), assuming that “b” is a distance from the front surface (emission surface) of the laser chip 401c to the inner surface of the stem 401f, “a” is a size of the laser chip 401c in Z-axis direction, and θ2 is a total divergence angle of laser light (stray light), on the beam's long axis, whose intensity lies in a range of 1/e² or more of the peak intensity.

α=2{(2b−a+L+t)tan(θ2/2)} (3)

Accordingly, laser light (stray light) emitted from the rear surface of the laser chip 401c is blocked by the back surface of the cap 401a with a ratio of about d²/α².

In this embodiment, since the emission opening 401b of the cap 401a serves as an aperture for restricting the incident area of laser light into the lens 402, the diameter of the emission opening 401b is set small as compared with an arrangement that the emission opening 401b is formed to allow transmittance of substantially all the laser light emitted from the front surface (emission surface) of the laser chip 401c. Accordingly, laser light (stray light) emitted from the rear surface of the laser chip 401c is less likely to be emitted from the emission opening 401b, which enables to suppress deterioration of the characteristics of the beam irradiation device resulting from the laser light (stray light).

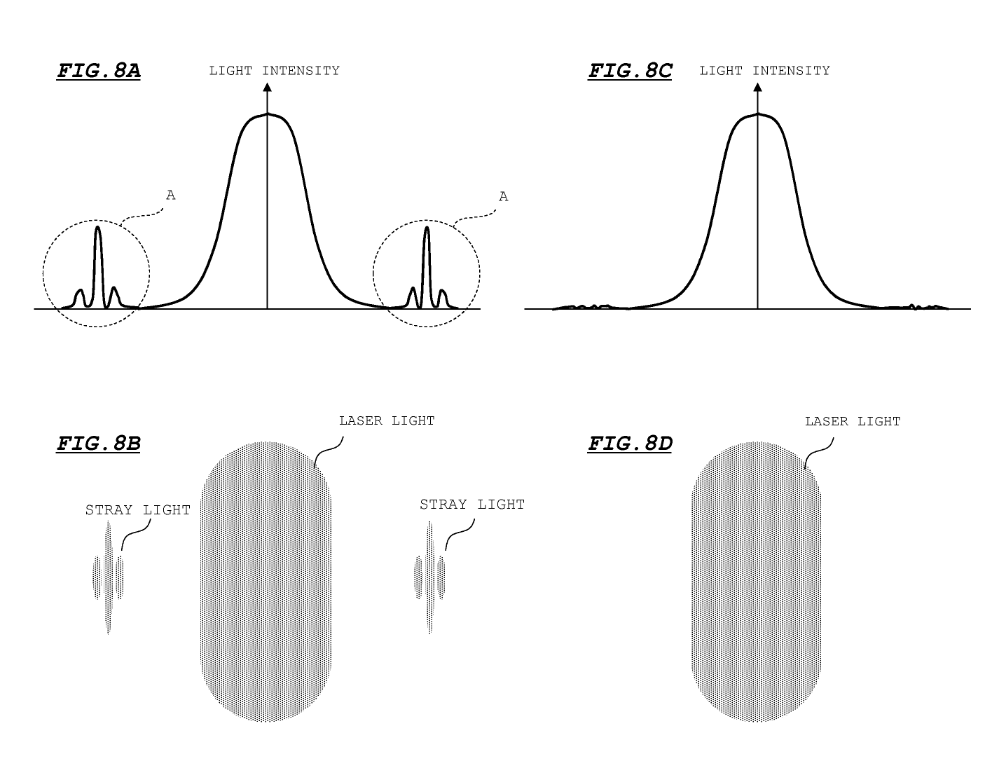

FIGS. 8A through 8D are diagrams schematically showing an advantage of the embodiment. FIGS. 8A and 8B are diagrams respectively showing a laser light intensity distribution in a targeted area and a laser light irradiation state, in the case (comparative example) where the diameter of the emission opening 401b is set to such a value as to allow transmittance of substantially all the laser light from the front surface (emission surface) of the laser chip 401c through the emission opening 401b. Further, FIGS. 8C and 8D are diagrams respectively showing a laser light intensity distribution in a targeted area and a laser light irradiation state, in the case (example of the embodiment) where the emission opening 401b serves as an aperture for restricting the incident area of laser light into the lens 402.

In the comparative example, since the diameter of the emission opening 401b is large, laser light (stray light) emitted from the rear surface of the laser chip 401c is likely to be emitted from the emission opening 401b. Since the laser light (stray light) is emitted from the emission opening 401b after reflection on the stem 401f, the laser light may be propagated in a direction different from the direction of laser light emitted from the front surface. As a result, the laser light (stray light) may be irradiated onto the targeted area at a position slightly displaced from the irradiation position of laser light emitted from the front surface (emission surface).

If the stem 401f is partially formed into a mirror surface, the intensity of laser light (stray light) reflected on the mirror surface portion is increased. As a result, if the laser light (stray light) reflected on the mirror surface portion is passed through the emission opening 401b and is irradiated onto the targeted area, as shown in FIGS. 8A and 8B, unwanted laser light (stray light) having a relatively large intensity may be irradiated at a position away from the irradiation position of laser light from the front surface (emission surface) of the laser chip 401c. If a condition of a targeted area is detected based on reflected light from the targeted area in this state, detection precision with respect to the targeted area may be lowered by an influence of the laser light (stray light).

On the other hand, in this embodiment, since the diameter of the emission opening 401b is set small, laser light (stray light) emitted from the rear surface of the laser chip 401c is less likely to be emitted from the emission opening 401b. Accordingly, stray light of a large intensity indicated by the portions A shown in FIG. 8A is less likely to be entered into a targeted area. As a result, as shown in FIGS. 8C and 8D, laser light from the front surface (emission surface) of the laser chip 401c can be properly irradiated onto the targeted area, and erroneous detection resulting from stray light can be suppressed.

The above effect is advantageously obtained by reducing the distance L shown in FIG. 7. Specifically, as the distance L is shortened, the diameter “d” of the emission opening 401b is decreased, based on the equation (1), and laser light (stray light) emitted from the rear surface of the laser chip 401c is less likely to pass through the emission opening 401b. Accordingly, erroneous detection resulting from stray light can be further advantageously suppressed.

As described above, in this embodiment, laser light emitted from the rear surface of the laser chip 401c can be effectively eliminated. Further, the above advantage can be achieved by a simplified arrangement of adjusting the diameter “d” of the emission opening 401b formed in the cap 401a. Furthermore, since the emission opening 401b functions as an aperture for restricting the incident area of laser light into the lens 402, there is no need of additionally providing an aperture, which enables to reduce the number of parts and simplify the arrangement.

The embodiment of the invention has been described as above. The invention is not limited to the foregoing embodiment, and the embodiment of the invention may be modified in various ways other than the above.

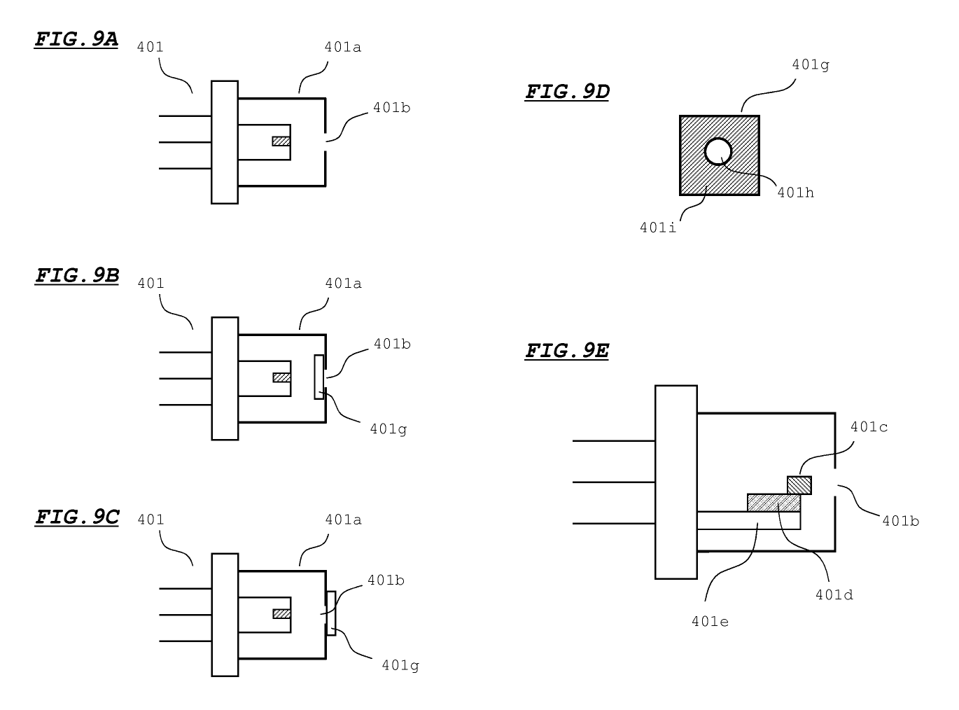

For instance, in the embodiment, as shown in FIG. 9A, the emission opening 401b is not covered. Alternatively, as shown in FIGS. 9B and 9C, the emission opening 401b may be covered by a transparent plate 401g such as a glass plate. In the modification, the transparent plate 401g may function as an aperture, in place of the emission opening 401b. Specifically, as shown in FIG. 9D, a circular light transmitting portion 401h is disposed on the laser light incident surface of the transparent plate 401g, and a light blocking portion 401i for blocking laser light is disposed around the light transmitting portion 401h. In the modification, the light transmitting portion 401h may be applied with an AR coat for suppressing surface reflection. Further alternatively, the laser light exit surface of the transparent plate 401g may also be applied with an AR (Anti-Reflection) coat.

In the modification, the diameter of the light transmitting portion 401h is set in the same manner as the diameter of the emission opening 401b in the embodiment. In the modification, since the light transmitting portion 401h functions as an aperture for restricting the incident area of laser light into the lens 402, the diameter of the emission opening 401b may be set larger than the diameter in the embodiment.

In the case where the transparent plate 401g functions as an aperture, disposing the transparent plate 401g on the inner side of the cap 401a as shown in FIG. 9B is advantageous in reducing the diameter of the light transmitting portion 401h, as compared with a case of disposing the transparent plate 401g on the outer side of the cap 401a as shown in FIG. 9C. Laser light to be emitted from the rear surface of the laser chip 401c in the arrangement shown in FIG. 9B is more advantageously blocked, as compared with the arrangement shown in FIG. 9C. On the other hand, since the transparent plate 401g is disposed on the outer side of the cap 401a in the arrangement shown in FIG. 9C, the arrangement shown in FIG. 9C is advantageous in performing position adjustment between the optical axis of laser light, and the center of the light transmitting portion 401h.

Further, as shown in FIG. 9E, it is preferable to form the laser chip 401c to project forwardly from the sub mount 401d. Since the distance between the emission surface of the laser chip 401c and the emission opening 401b is reduced by the above arrangement, it is possible to reduce the diameter of the emission opening 401b. With the above arrangement, it is possible to block a larger amount of laser light to be emitted from the rear surface of the laser chip 401c. Further, laser light emitted from the laser chip 401c is less likely to be blocked by the sub mount 401d.

Further, in this embodiment, the emission opening 401b has a circular shape. Alternatively, the emission opening 401b may have an elliptical shape to block laser light, in the direction of the beam's short axis, whose intensity is smaller than 1/e² of a peak intensity of the laser light, as well as the direction of the beam's long axis. Similarly, in the case where the light transmitting portion 401h is disposed on the transparent plate 401g, the light transmitting portion 401h may have an elliptical shape. In both of the modifications, laser light whose intensity lies in a range of 1/e² or more of the peak intensity is entered into the lens 402 along the entire circumference of the lens 402.

Alternatively, the emission opening 401b or the light transmitting portion 401h may be configured to block laser light, on the beam's long axis, in a range slightly broader or slightly narrower than the range of laser light whose intensity is smaller than 1/e² of the peak intensity. Further alternatively, the emission opening 401b or the light transmitting portion 401h may be configured to block laser light, on the beam's short axis, in a range slightly broader or slightly narrower than the range of laser light whose intensity is smaller than 1/e² of the peak intensity.

A mirror actuator other than the one shown in FIG. 1, a scan mechanism for scanning by displacing a lens, a polygon mirror, or a like device may be used as the actuator for scanning laser light.

The embodiment of the invention may be changed or modified in various ways as necessary, as far as such changes and modifications do not depart from the scope of the present invention hereinafter defined.

What is claimed is:

1. A beam irradiation device, comprising:
a semiconductor laser;
a lens into which laser light emitted from the semiconductor laser is entered; and
a scanning portion which causes the laser light transmitted through the lens to scan a targeted area, wherein
the semiconductor laser includes:
a laser chip;
a cap which houses the laser chip; and
an emission opening formed in the cap and adapted to pass laser light emitted from the laser chip, and
the emission opening has an aperture which restricts an incident area of the laser light into the lens.

2. The beam irradiation device according to claim 1, wherein
the emission opening serves as the aperture.

3. The beam irradiation device according to claim 1, wherein
the aperture is disposed in a transparent cover member which covers the emission opening.

4. The beam irradiation device according to claim 1, wherein
the aperture blocks laser light in a range where an intensity of the laser light on a beam's long axis is smaller than about 1/e² of a peak intensity of the laser light.

5. The beam irradiation device according to claim 4, wherein
a size “d” of the emission opening in a direction in parallel with the beam's long axis is expressed by:
d=2×{(L+t)tan(θ/2)}
where θ is a total divergence angle of the laser light which defines a range where an intensity of the laser light on the beam's long axis is equal to or larger than about 1/e² of the peak intensity, L is a distance from an emission surface of the laser chip to an inner surface of the cap in a propagating direction of the laser light, and “t” is a thickness of the cap at a portion corresponding to the emission opening.

6. A semiconductor laser device, comprising:
a laser chip;
a cap which houses the laser chip; and
an emission opening formed in the cap and adapted to pass laser light emitted from the laser chip, wherein
the emission opening has an aperture which blocks light at an outer portion of the laser light, and
the aperture blocks laser light in a range where an intensity of the laser light on a beam's long axis is smaller than about 1/e² of a peak intensity of the laser light.

7. The semiconductor laser device according to claim 6, wherein
a size “d” of the emission opening in a direction in parallel with the beam's long axis is expressed by:
d=2×{(L+t)tan(θ/2)}
where θ is a total divergence angle of the laser light which defines a range where an intensity of the laser light on the beam's long axis is equal to or larger than about 1/e² of the peak intensity, L is a distance from an emission surface of the laser chip to an inner surface of the cap in a propagating direction of the laser light, and “t” is a thickness of the cap at a portion corresponding to the emission opening.
